(19) United States
(12) Patent Application Publication
(10) Pub. No.: US 2025/0279831 A1
(43) Pub. Date: Sep. 4, 2025

(54) REMOVAL OF AVAILABILITY IMPACT FOR REMOTELY LOCATED EDGE DEVICES VIA AERONAUTIC DATA EXTRACTION

(71) Applicant: Dell Products L.P., Round Rock, TX (US)

(72) Inventors: Tomer Shachar, Beer-Sheva (IL); Yevgeni Gehtman, Modi’in (IL); Maxim Balin, Gan-Yavne (IL)

(21) Appl. No.: 18/591,312

(22) Filed: Feb. 29, 2024

(51) Int. Cl. H04B 10/112; G05D 1/656; G05D 105/80; G05D 109/25

(52) U.S. Cl. CPC H04B 10/1129; G05D 1/656; G05D 2105/80; G05D 2109/254

(57) ABSTRACT

Techniques for extracting data from a remotely located edge node are disclosed. A service causes a drone to travel a flight path to reach a designated region within which the edge node is located. While the drone is within the designated region, the service establishes a LiFi communication session with the edge node. The service then collects data from the edge node. The service terminates the LiFi communication session. The service causes the drone to continue along the flight path until reaching an infrastructure node. The service transmits the collected data to the infrastructure node.

### COPYRIGHT AND MASK WORK NOTICE

A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever.

### FIELD OF THE INVENTION

Embodiments of the present invention generally relate to extracting data from a remotely located edge node. More particularly, at least some embodiments of the invention relate to systems, hardware, software, computer-readable media, and methods for using aeronautic techniques to extract data from a remotely located edge device so the edge device can continue to generate and store data.

### BACKGROUND

Light fidelity (LiFi or Li-Fi) is a type of wireless communication technology that relies on light to transmit data between different devices. A LiFi communication session is established when one device uses its LiFi transceiver to send or receive light transmissions to another LiFi transceiver of a different device. Because LiFi relies on the transmission of light, one will appreciate how it is typically the case that the two LiFi transceivers remain within the line-of-sign of each other.

Communications made via a LiFi communication session can be transmitted at a high speed, higher even than traditional wireless fidelity (WiFi) transmissions. Also, these transmissions can occur using different spectrums of light, such as the visible light spectrum, the infrared light spectrum, or even the ultraviolet light spectrum. Whereas traditional WiFi communications occur via the use of modulated radio frequencies to induce an antenna's electrical tension, LiFi uses the modulation of light to transmit data. As a result, LiFi can beneficially be used in conditions that may not be conducive to radio frequency transmissions, such as areas where radio interference may be present.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 illustrates an example computing architecture for extracting data from a remotely located edge node.

FIG. 2 illustrates an example of a drone's flight path.

FIG. 3 illustrates an example of a data extraction technique.

FIGS. 4A, 4B, 4C, and 4D illustrate examples of data extraction.

FIG. 5 illustrates a flowchart of an example method for extracting data from a remotely located edge node.

FIG. 6 illustrates an example computer system that can be configured to perform any of the disclosed operations.

### DETAILED DESCRIPTION

Edge devices (aka “edge nodes”) can be located at remote locations where network infrastructure does not exist. Typically, edge devices are not designed to store data for long periods of time. Hence, it is desirable to find an innovative technique to allow for the transmission of data using a scheduled, high bandwidth technique to keep the edge device operational and to remove negative effects with regard to that node's availability.

One of the benefits of LiFi wireless communication is that it transmits data at very high speed. Another benefit is that the transmission of the data can take place over large distances, provided a direct line of sight is maintained. Thus, a potential downside of the above-mentioned technology is the fact that, for continuous communication, LiFi communications require a clear line of communication between the transmitter and the receiver. As various examples, transmission may be impeded due to topography constraints (e.g., mountains) or objects (e.g., buildings, trees, etc.). The disclosed embodiments provide an aeronautic-based solution to extracting data from a remotely located edge device using LiFi technology.

The disclosed embodiments are directed to various innovative solutions that include a LiFi transceiver (i.e. a unit having both transmission and reception capabilities) on the edge device, where that transceiver's aiming direction can optionally be positioned in a generally vertical orientation (e.g., to prevent physical interferences/constraints, as mentioned above). At a fixed cadence or route frequency, a drone, which also includes a LiFi transceiver, flies over the edge device and serves as a “data collector”. That is, a LiFi communication session is established between the two transceivers, and the drone is able to capture the edge node's data. After the data is collected, the edge node can purge its buffer or memory to make room for new data. After the data is collected by the drone, the drone returns to a node that does have a stable network infrastructure. After the drone arrives at that node, which can also operate as a charging station for the drone, the drone can transmit all of its collected data to the node, which can then upload the data to the cloud or to the Internet.

By performing the disclosed operations, the embodiments beneficially remove the “availability” obstacles that exist for remotely located edge devices (i.e. devices that are not connected to a wide area network). The removal of these obstacles is performed via an aeronautic data extraction and LiFi wireless communication technique. As another benefit, the disclosed embodiments now allow customers to locate edge devices/nodes in remote locations where network infrastructure has historically been absent. The embodiments also enable continuous or near-continuous workflow of those edge nodes.

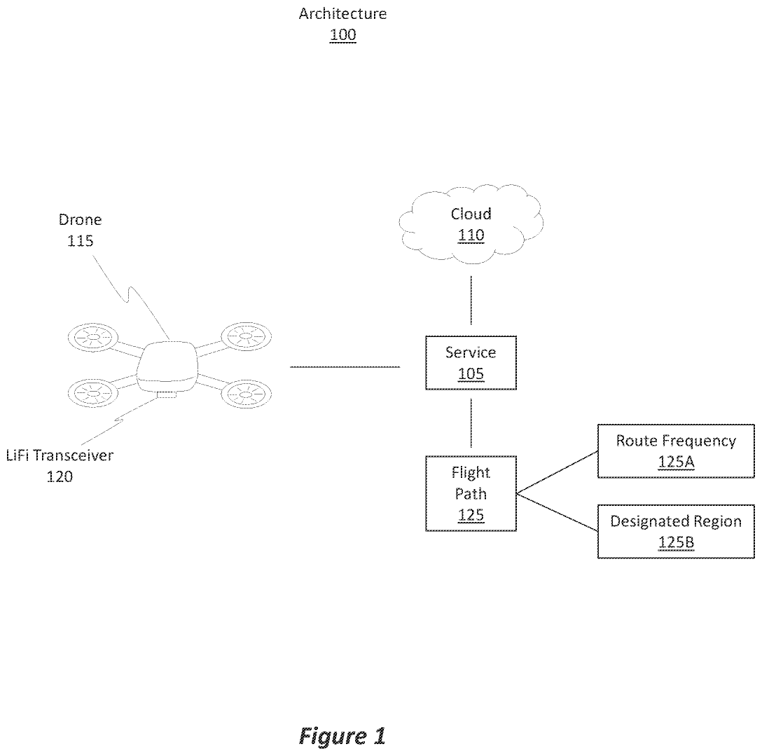

Attention will now be directed to FIG. 1, which illustrates an example architecture 100 in which the disclosed principles may be employed. Architecture 100 shows a service 105.

As used herein, the term “service” refers to an automated program that is tasked with performing different actions based on input. In some cases, service 105 can be a deterministic service that operates fully given a set of inputs and without a randomization factor. In other cases, service 105 can be or can include a machine learning (ML) or artificial intelligence engine. The ML engine enables service 105 to operate even when faced with a randomization factor.

As used herein, reference to any type of machine learning or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

In some implementations, service 105 is a cloud service operating in a cloud 110 environment. In some implementations, service 105 is a local service operating on a local device, such as a drone 115. In some implementations, service 105 is a hybrid service that includes a cloud component operating in the cloud and a local component operating on a local device. These two components can communicate with one another.

Regardless of whether service 105 is implemented in the cloud 110 or in the drone 115, service 105 is generally tasked with directing the operations of the drone 115 so as to receive data from an edge device. To do so, the drone 115 is equipped with a LiFi transceiver 120 that is capable of sending or receiving data from another LiFi transceiver. Drone 115 may also have one or more other communication mechanisms to transfer data, such as perhaps to the node connected to the cloud 110. In one scenario, drone 115 can be connected to the infrastructure node via any type of wired or wireless connection, such as a USB connection, a WiFi connection, a LiFi connection, any type of near field connection, Bluetooth connection, or any other type of connection usable to transmit data from the drone 115 to the infrastructure node.

In some instances, the infrastructure node can also operate as a charging unit for the drone 115. Thus, while the drone 115 is transmitting its data to the infrastructure node, the infrastructure node can also charge the drone 115.

Service 105 is tasked with causing the drone 115 to follow a flight path to reach an edge node. In some cases, the flight path is predefined, and the drone 115 follows the flight path automatically. In some cases, the flight path may not be predefined and instead may be dynamically generated on the fly. For instance, the flight path might change based on environmental conditions or other circumstances that occur.

Typically, the edge node is not connected to a wide area network, yet the edge node is collecting data. Edge nodes often have a limited memory capacity or memory buffer capacity. If the edge node's data is not transferred to another device, then the data stored on the edge node may be overwritten or the edge node may not be able to continue to generate or save data. As a result, it is desirable to provide a mechanism by which the data on the edge node, which is not connected to a wide area network (e.g., the Internet), can divest itself of the data so it can continue to generate more data. The disclosed embodiments provide such a mechanism. In particular, the disclosed embodiments provide a way to obtain data from an edge node that is located in a remote manner so that the edge node can continue to generate and save data without a concern of overwriting that data or otherwise losing that data.

To achieve the above objectives, service 105 establishes a route frequency 125A (aka cadence) for a flight path 125 of drone 115, which is equipped with the LiFi transceiver 120. The route frequency 125A indicates how often drone 115 is to travel the flight path 125. As one example, the route frequency 125A may be set so that the drone flies to the edge node at least once every hour for at least a select number of hours. The flight path 125 also includes a designated region 125B within which an edge node is supposedly located. Typically, the flight path 125 includes global positioning system (GPS) coordinates of the edge node, and the drone 115 is tasked with flying to those coordinates.

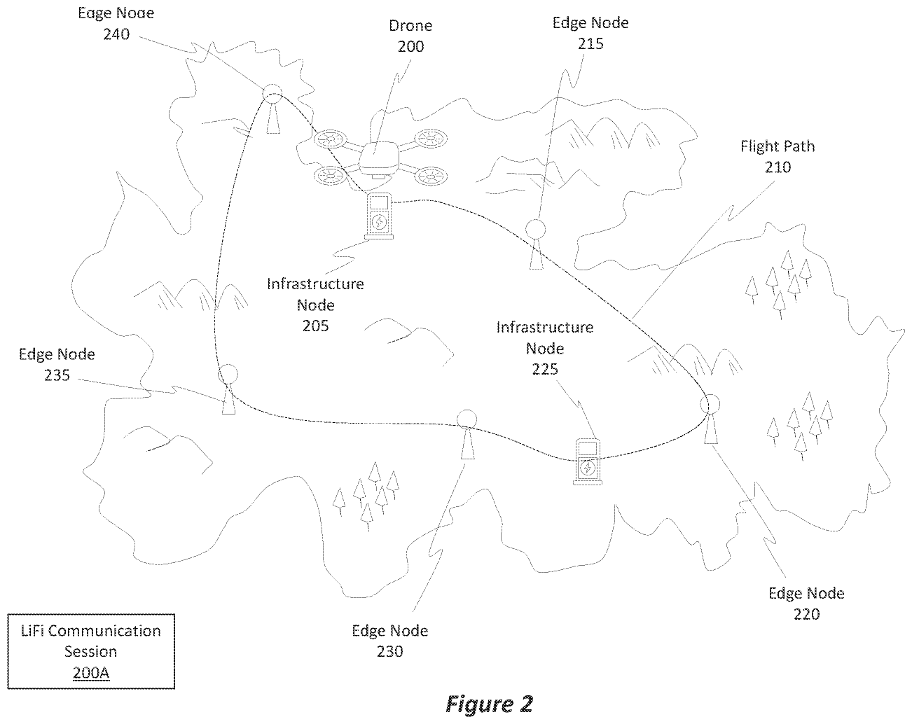

Service 105 then causes the drone 115 to travel the flight path 125 to reach the designated region 125B. FIG. 2 is illustrative.

FIG. 2 shows an environment in which the drone 115 is operating. In particular, FIG. 2 shows a drone 200, which is representative of drone 115 from FIG. 1.

Initially, drone 200 is stationed at a first infrastructure node 205. This first infrastructure node 205 operates as a source for the drone 200 to download whatever data it may have collected from one or more edge nodes. This first infrastructure node 205 can also operate as a charging station for the drone 200.

FIG. 2 also shows a flight path 210 of the drone 200. Notice, this flight path 210 originates at the infrastructure node 205 (though it can originate anywhere). The first stop along the flight path 210 for the drone 200 is a first edge node 215. While at the position of edge node 215, drone 200 establishes a LiFi communication session with edge node 215. Edge node 215 then transmits its cached, buffered, or stored data to drone 200, which includes sufficient memory to store that information.

Stated differently, while the drone is within a designated region within which edge node 215 is located, service 105 establishes a LiFi communication session 200A with edge node 215. Service 105 then facilitates the collection of data from edge node 215 during the LiFi communication session 200A.

After edge node 215's data has been transmitted to drone 200, service 105 terminates the LiFi communication session. This termination may occur via an active termination in which the service 105 ends the communication session by stopping LiFi transmissions. Additionally, or alternatively, the termination may occur in a passive manner simply as a result of drone 200 leaving a direct line of sight with edge node 215. In any event, this termination operates as a trigger event for edge node 215 to purge its memory buffer. By purging or deleting the contents of its memory buffer, edge node 215 should now have sufficient memory capacity to store additional data until such time as drone 200 returns to collect more of that edge node's data.

Service 105 then causes drone 200 to continue along the flight path 210. For instance, drone 200 may arrive at the destination of edge node 220 and perform similar or the same operations as those that were performed for edge node 215.

Service 105 then causes drone 200 to continue along the flight path 210 until reaching another infrastructure node 225. Infrastructure node 225 may be configured in a similar or same manner as infrastructure node 205. That is, infrastructure node 225 can operate as a data dump for drone 200 to dump or download its data. Infrastructure node 225 can also operate as a charging station for drone 200.

Drone 200 then continues on the flight path 210 to reach another edge node 230, another edge node 235, and yet another edge node 240. Eventually, drone 200 continues along the flight path 210 until it reaches a final infrastructure node (e.g., infrastructure node 205).

At the infrastructure nodes 225 and 205, service 105 causes drone 200 to transmit or download its collected data to those infrastructure nodes. Drone 200 may also be charged at those infrastructure nodes. At each of the edge nodes, drone 200 can collect that edge node's data and can trigger that edge node to wipe, purge, or delete its memory of any data that has already been captured by drone 200 so that new data can be stored by the edge node.

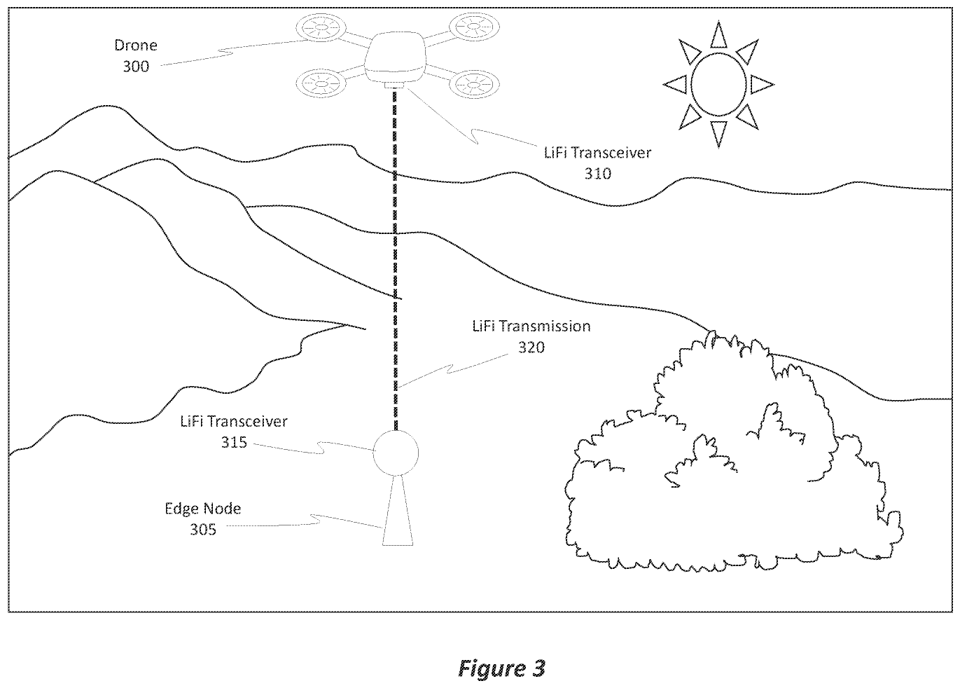

FIG. 3 shows a scenario involving a drone 300 and an edge node 305, which are representative of the drones and edge nodes mentioned thus far. Drone 300 is equipped with a LiFi transceiver 310, and edge node 305 is also equipped with a LiFi transceiver 315.

In the scenario shown in FIG. 3, a LiFi communication session has been established between drone 300 and edge node 305. As a result, one or more LiFi transmissions can be sent or received by either one of the LiFi transceivers 310, 315, as shown by LiFi transmission 320.

In FIG. 3, drone 300 is positioned some height above and immediately vertical/overhead or at least approximately vertical/overhead to edge node 305. While in this overhead position, a direct line of sight is maintained. While also in this overhead position, drone 300 remains stationary or approximately stationary. That is, while in this position, drone 300 is not mobile, or at least any movement it makes is less than a threshold amount of movement (e.g., less than 1 meter of movement per duration of time (e.g., 1 second), or less than 0.5 meters of movement per duration of time, or perhaps less than 0.25 meters of movement per duration of time, or perhaps even less than 0.1 meters of movement per duration of time).

The separation distance between drone 300 and edge node 305 can be any distance. For instance, the separation distance can be any value between the range of 0.5 meters and 10 kilometers. In some cases, the separation distance is 5 meters, 10 meters, 15 meters, 20 meters, more than 20 meters, 1 kilometer, or more than 1 kilometer. Accordingly, in some embodiments, drone 300 is caused to remain relatively stationary while the edge node is transmitting its data to the drone.

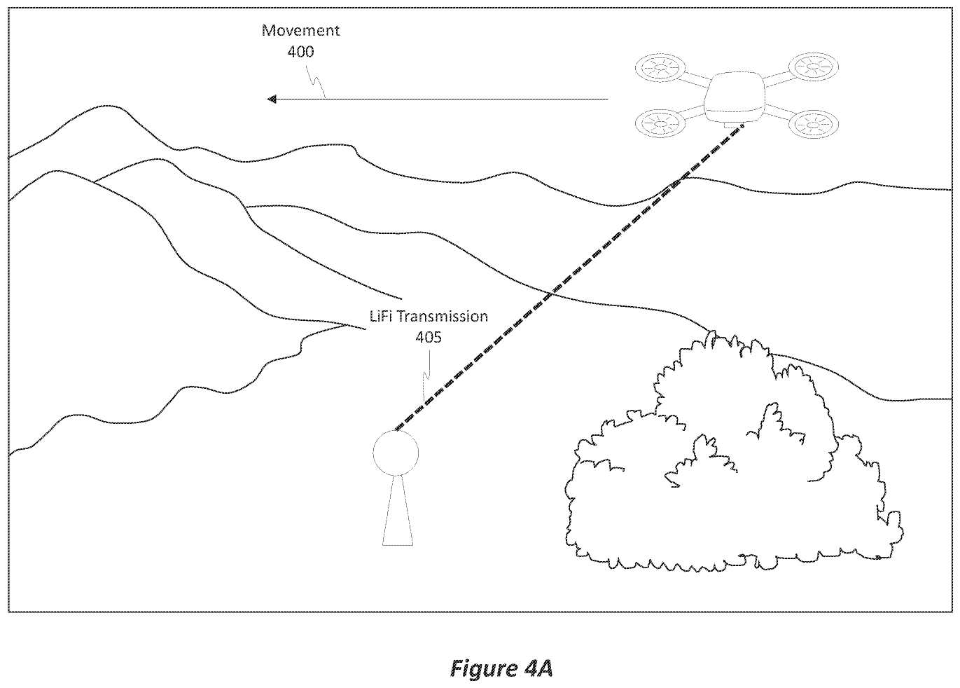

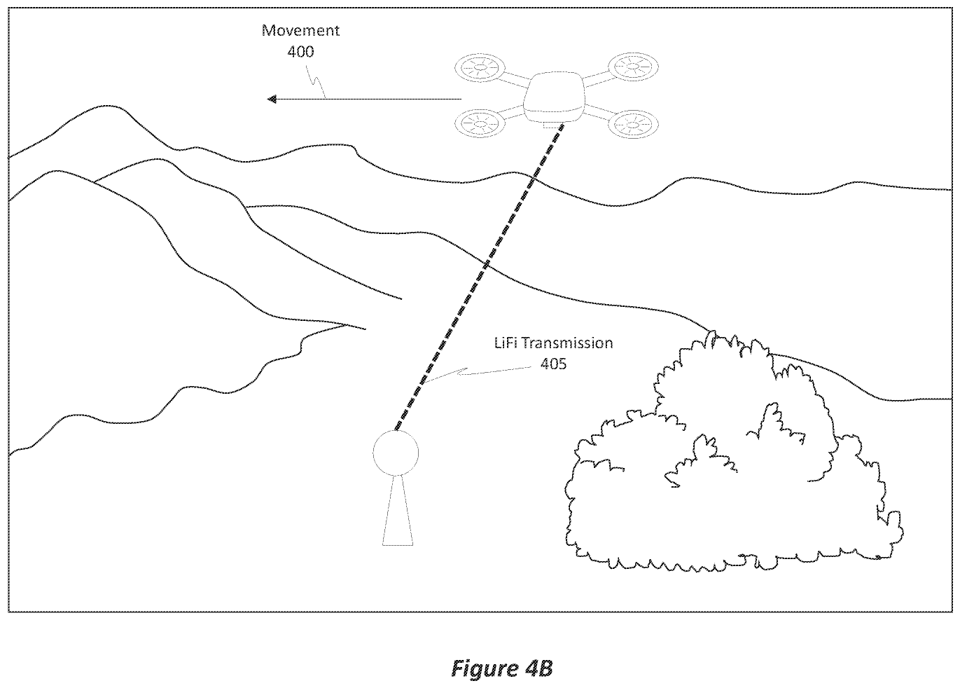

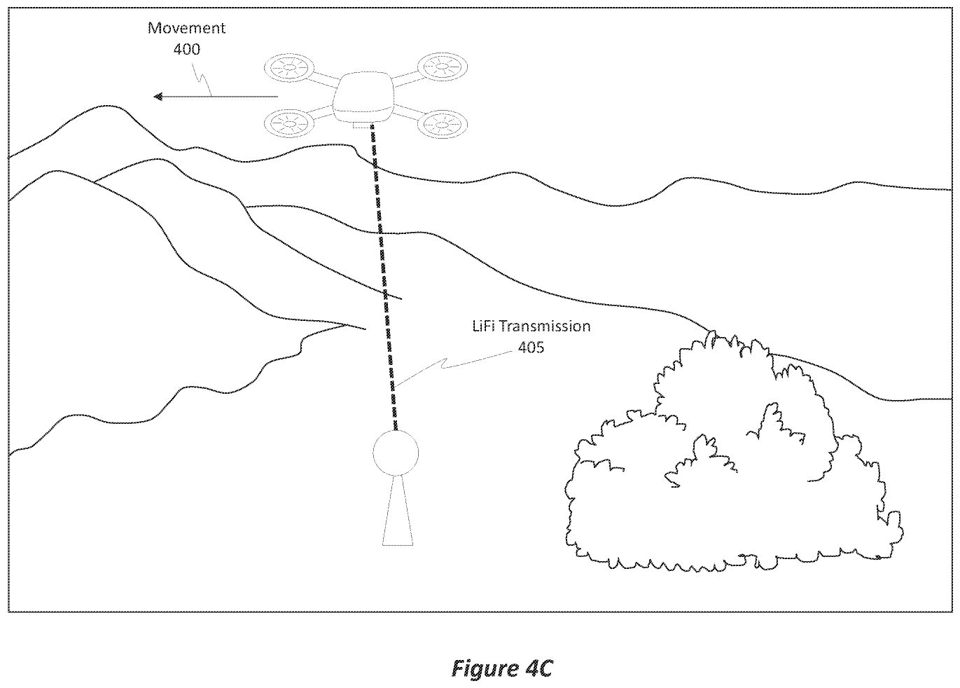

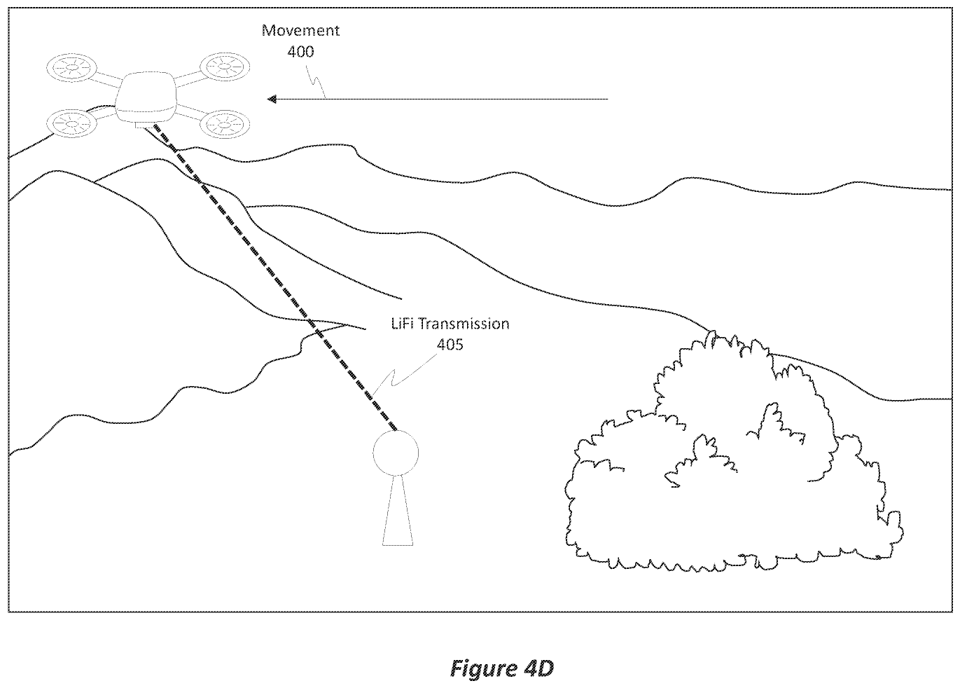

In other embodiments, the drone can move while the data dump is ongoing, as shown in FIGS. 4A-4D. FIG. 4A shows a scenario where the drone is moving (as shown by movement 400) while a LiFi transmission 405 is ongoing. In such a scenario, the two transceivers are tasked with tracking one another so as to maintain a direct line of sight. Thus, the transceivers on both units (e.g., the drone and the edge node) can dynamically adjust their angles so as to maintain the direct line of sight connection. Typically, the rate of the movement 400 is set so as to not exceed a given threshold. For instance, in some cases, the threshold may be set at 0.5 meters per second, 1 meter per second, 2 meters per second, or some other value. In some cases, the threshold may be defined using a range of values, such as the following range: 0.1 meters per second to 5 meters per second. The rate of the drone's movement 400 is then set so as to not exceed this threshold.

FIG. 4B shows how the LiFi transmission 405 is maintained during the movement 400. Similarly, FIGS. 4C and 4D show how the LiFi transmission 405 is maintained during the movement 400. Regarding the tracking of the LiFi transceivers, this tracking can optionally occur using speed and trajectory information of the drone. That information can initially be passed to the edge node. If the drone retains a constant speed and trajectory, the two transceivers can be dynamically re-aimed based on that information in a manner so that the drone is constantly tracked by the edge node.

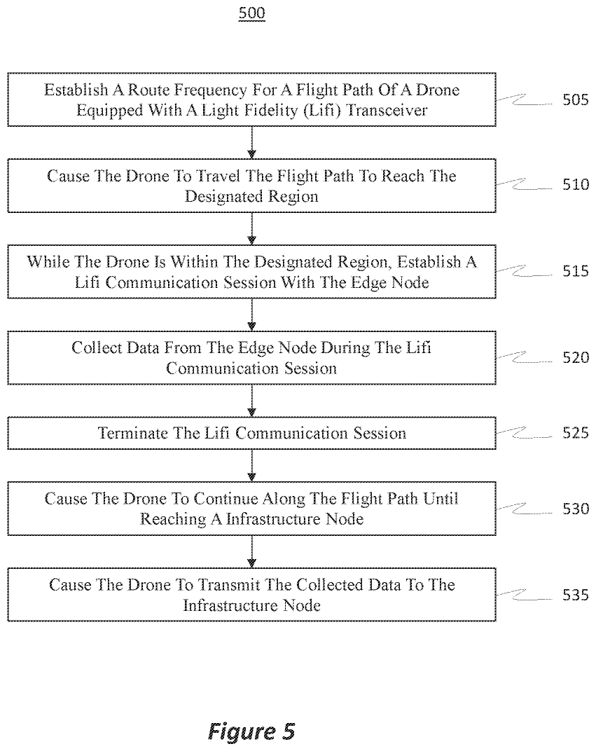

Attention will now be directed to FIG. 5, which illustrates a flowchart of an example method 500 for establishing a LiFi communication session between a drone and an edge node. Method 500 can be implemented by the drone 115 of FIG. 1; furthermore, method 500 can be implemented by the service 105 of FIG. 1, where the service 105 operates in drone 115.

Method 500 includes an act (act 505) of establishing a predefined route frequency for a flight path of a drone equipped with a LiFi transceiver. The route frequency indicates how often the drone is to travel the flight path. The flight path includes a designated region within which an edge node is supposedly located. In this regard, the drone is caused to travel the flight path in accordance with the predefined route frequency.

In some embodiments, the route frequency is based on a size of the memory buffer of the edge node. That is, the route frequency is selected so the flight of the drone occurs at a rate so that the drone can download the edge node's data often enough so that the edge node need not overwrite existing data and need not refrain from generating or storing new data because the memory is full. If, in a rare circumstance, the memory does become full, the frequency is set so that the amount of time where the memory is full, and thus cannot be added to, is reduced as much as possible, such as below a threshold amount of time.

In one example scenario, the route frequency is at least one flight per 24 hour cycle. In another example scenario, the route frequency is at least one flight per 1 hour cycle. Of course, a range can be established for the frequency. This range can be anywhere from a select number of minutes to a select number of hours or perhaps even a select number of days.

Act 510 includes causing the drone to travel the flight path to reach the designated region. Optionally, the designated region may be marked via a geo-fence. For instance, after the drone enters the geo-fenced region, the drone may be triggered to start to attempt to connect with the edge node whereas it was not triggered prior to entering the geo-fenced region. As another option, the designated region may be defined by a set of global positioning system (GPS) coordinates.

While the drone is within the designated region, act 515 includes attempting to establish a LiFi communication session with the edge node. In most scenarios, establishing the LiFi communication session is initiated by the drone, though in some scenarios, establishing the LiFi communication session is initiated by the edge node.

Typically, the LiFi communication session is established without any issues. In some instances, however, the LiFi communication session may not be established. Such a scenario may occur, for example, when the edge device has perhaps shifted to a new location, when an impeding object is blocking the edge device, or when environmental conditions cause visual disruptions. In such scenarios, drone can respond in a variety of ways.

In one example scenario, the drone may be equipped with machine learning intelligence. This intelligence can cause the drone to acquire pictures of the region where the edge device is supposed to be located and pictures of a surrounding region. The machine learning intelligence can then perform image segmentation in an attempt to identify the edge device. If the edge device is identified via the segmentation process, the machine learning intelligence can then navigate the drone to the location of the edge device. If that location is different than the original location, the machine learning intelligence can update the flight path to include the new location details. An alert can also be generated based on the moved edge device. After the drone returns to the infrastructure node, that alert can be provided to an administrator.

The drone can respond in another manner. For instance, if the LiFi communication session cannot be established, drone can drop to a given altitude and attempt to communicate with the edge node using a different connection mechanism, such as perhaps Bluetooth or some other near field communication technique. The altitude at which the drone hovers would correspond to the strength of the wireless field that can be generated between the drone and the edge node.

The drone can also respond by generating a number of images of the area and then simply continuing on with its traversal of the flight path. After the drone arrives at an infrastructure node, the drone can upload the images it took so another entity (e.g., perhaps an administrator or another machine learning algorithm) can analyze the images in an attempt to determine the status or state of the edge node, provided it is visible in the images. The analysis of the images might reveal that the edge node has been damaged. If that is the case, then a work order can be filed to fix the edge node.

Assuming the LiFi communication session can be established, act 520 includes collecting data from the edge node during the LiFi communication session. In some cases, the drone is stationary (e.g., hovers) or remains approximately stationary while the LiFi communication session is established and while the data is being collected. In some cases, the drone is mobile while the LiFi communication session is established and while the data is being collected.

Regardless of whether the drone is mobile or stationary, during the LiFi communication session, the drone maintains a line-of-sight with the edge node. In some implementations, an aiming direction of the edge node's LiFi transceiver is adjustable, and the aiming direction may be adjusted while the drone progressively moves overhead of the edge node during the LiFi communication session. In other scenarios, the aiming direction is directed at a fixed angle (e.g., often vertical relative to the ground plane, or 90 degrees relative to the ground plane), and the drone maintains a fixed position corresponding to the fixed angle.

Stated differently, the drone may be positioned vertically above the edge node while the data is collected. As another option, during the communication session, the drone hovers above the edge node by at least 5 meters, 100 meters, 1 kilometer, or some distance between about 5 meters and about 5 kilometers or 10 kilometers.

Act 525 includes terminating the LiFi communication session. This termination operates as a trigger event for the edge node to purge a memory buffer. In doing so, the edge node can now save new data. In some scenarios, the edge node purges only the data that was successfully uploaded or transmitted to the drone.

Act 530 includes causing the drone to continue along the flight path until reaching a final infrastructure node. Prior to reaching that final infrastructure node, the drone may have collected data from any number of other edge nodes as well. The final infrastructure node may be the same infrastructure node as the one that the drone originally departed from. If that is the case, then the drone has completed one full circuit, and the drone may repeat that circuit again after dumping its data and/or after receiving a battery charge.

Act 535 then includes causing the drone to transmit the collected data to the final infrastructure node. While at this infrastructure node, the drone can also recharge its battery unit(s). Accordingly, the disclosed embodiments beneficially enable data from a remotely located edge node, particularly one that is not connected to a wide area network, to reach the cloud.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. Also, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, client, engine, agent, services, and component are examples of terms that may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

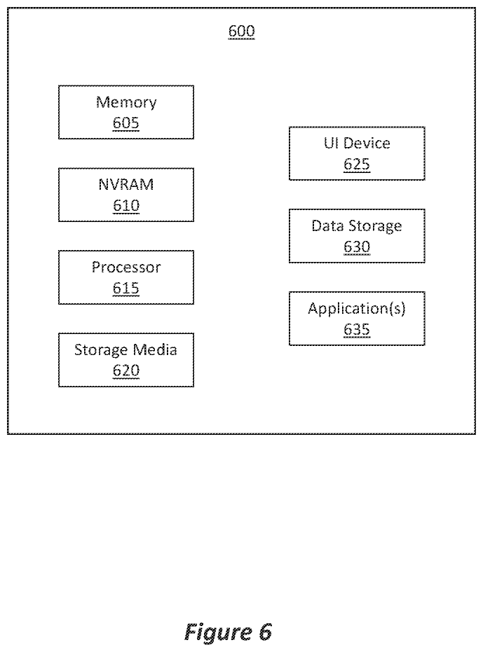

With reference briefly now to FIG. 6, any one or more of the entities disclosed, or implied, by the Figures and/or elsewhere herein, may take the form of, or include, or be implemented on, or hosted by, a physical computing device, one example of which is denoted at 600. Also, where any of the aforementioned elements comprise or consist of a virtual machine (VM), that VM may constitute a virtualization of any combination of the physical components disclosed in FIG. 6.

In the example of FIG. 6, the physical computing device 600 includes a memory 605 which may include one, some, or all, of random access memory (RAM), non-volatile memory (NVM) 610 such as NVRAM for example, read-only memory (ROM), and persistent memory, one or more hardware processors 615, non-transitory storage media 620, UI device 625, and data storage 630. One or more of the memory 605 of the physical computing device 600 may take the form of solid-state device (SSD) storage. Also, one or more applications 635 may be provided that comprise instructions executable by one or more hardware processors 615 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein. The physical device 600 may also be representative of an edge system, a cloud-based system, a datacenter or portion thereof, or other system or entity.

The disclosed embodiments can be implemented in numerous different ways, as described in the various different clauses recited below.

Clause 1. A method comprising: causing a drone to travel a flight path to reach a designated region within which an edge node is located; while the drone is within the designated region, establishing a light fidelity (LiFi) communication session with the edge node; collecting data from the edge node during the LiFi communication session; terminating the LiFi communication session, said terminating operates as a trigger event for the edge node to purge a memory buffer of the edge node; causing the drone to continue along the flight path until reaching an infrastructure node; and causing the drone to transmit the collected data to the infrastructure node.

Clause 2. The method of any of the preceding clauses, wherein the drone is approximately stationary while the LiFi communication session is established.

Clause 3. The method of any of the preceding clauses, wherein the drone is mobile while the LiFi communication session is established.

Clause 4. The method of any of the preceding clauses, wherein the drone is mobile while the data is collected from the edge node.

Clause 5. The method of any of the preceding clauses, wherein the drone is positioned vertically above the edge node while the data is collected.

Clause 6. The method of any of the preceding clauses, wherein the drone is caused to travel the flight path in accordance with a predefined route frequency.

Clause 7. The method of any of the preceding clauses, wherein, during the communication session, the drone hovers above the edge node by at least 5 meters.

Clause 8. The method of any of the preceding clauses, wherein, during the communication session, the drone hovers above the edge node by at least 100 meters.

Clause 9. The method of any of the preceding clauses, wherein, during the communication session, the drone hovers above the edge node by at least 1 kilometer.

Clause 10. The method of any of the preceding clauses, wherein, during the LiFi communication session, the drone maintains a line-of-sight with the edge node.

Clause 11. A method comprising: establishing a route frequency for a flight path of a drone equipped with a light fidelity (LiFi) transceiver, wherein the route frequency indicates how often the drone is to travel the flight path, and wherein the flight path includes a designated region within which an edge node is supposedly located; causing the drone to travel the flight path to reach the designated region; while the drone is within the designated region, establishing a LiFi communication session with the edge node; collecting data from the edge node during the LiFi communication session; terminating the LiFi communication session, said terminating operates as a trigger event for the edge node to purge a memory buffer; causing the drone to continue along the flight path until reaching an infrastructure node; and causing the drone to transmit the collected data to the infrastructure node.

Clause 12. The method of any of the preceding clauses, wherein the route frequency is based on a size of the memory buffer of the edge node.

Clause 13. The method of any of the preceding clauses, wherein the route frequency is at least one flight per 24 hour cycle.

Clause 14. The method of any of the preceding clauses, wherein the route frequency is at least one flight per 1 hour cycle.

Clause 15. The method of any of the preceding clauses, wherein the designated region is marked via a geo-fence.

Clause 16. The method of any of the preceding clauses, wherein an aiming direction of a LiFi transceiver of the edge node is adjustable, and wherein the aiming direction is adjusted while the drone progressively moves overhead of the edge node during the LiFi communication session.

Clause 17. The method of any of the preceding clauses, wherein the designated region is a defined set of global positioning system (GPS) coordinates.

Clause 18. The method of any of the preceding clauses, wherein establishing the LiFi communication session is initiated by the drone.

Clause 19. A method comprising: establishing a route frequency for a flight path of a drone equipped with a light fidelity (LiFi) transceiver, wherein the route frequency indicates how often the drone is to travel the flight path, and wherein the flight path includes a designated region within which an edge node is supposedly located; causing the drone to travel the flight path to reach the designated region; while the drone is within the designated region, establishing a LiFi communication session with the edge node, wherein the LiFi communication session is initiated by the drone; collecting data from the edge node during the LiFi communication session; terminating the LiFi communication session, said terminating operates as a trigger event for the edge node to purge a memory buffer; causing the drone to continue along the flight path until reaching an infrastructure node; and causing the drone to transmit the collected data to the infrastructure node.

Clause 20. The method of any of the preceding clauses, wherein the drone remains approximately stationary while the LiFi communication session is active.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
causing a drone to travel a flight path to reach a designated region within which an edge node is located;
while the drone is within the designated region, establishing a light fidelity (LiFi) communication session with the edge node;
collecting data from the edge node during the LiFi communication session;
terminating the LiFi communication session, said terminating operates as a trigger event for the edge node to purge a memory buffer of the edge node;
causing the drone to continue along the flight path until reaching an infrastructure node; and
causing the drone to transmit the collected data to the infrastructure node.

2. The method of claim 1, wherein the drone is approximately stationary while the LiFi communication session is established.

3. The method of claim 1, wherein the drone is mobile while the LiFi communication session is established.

4. The method of claim 1, wherein the drone is mobile while the data is collected from the edge node.

5. The method of claim 1, wherein the drone is positioned vertically above the edge node while the data is collected.

6. The method of claim 1, wherein the drone is caused to travel the flight path in accordance with a predefined route frequency.

7. The method of claim 1, wherein, during the communication session, the drone hovers above the edge node by at least 5 meters.

8. The method of claim 1, wherein, during the communication session, the drone hovers above the edge node by at least 100 meters.

9. The method of claim 1, wherein, during the communication session, the drone hovers above the edge node by at least 1 kilometer.

10. The method of claim 1, wherein, during the LiFi communication session, the drone maintains a line-of-sight with the edge node.

11. A method comprising:
establishing a route frequency for a flight path of a drone equipped with a light fidelity (LiFi) transceiver, wherein the route frequency indicates how often the drone is to travel the flight path, and wherein the flight path includes a designated region within which an edge node is supposedly located;
causing the drone to travel the flight path to reach the designated region;
while the drone is within the designated region, establishing a LiFi communication session with the edge node;
collecting data from the edge node during the LiFi communication session;
terminating the LiFi communication session, said terminating operates as a trigger event for the edge node to purge a memory buffer;
causing the drone to continue along the flight path until reaching an infrastructure node; and
causing the drone to transmit the collected data to the infrastructure node.

12. The method of claim 11, wherein the route frequency is based on a size of the memory buffer of the edge node.

13. The method of claim 11, wherein the route frequency is at least one flight per 24 hour cycle.

14. The method of claim 11, wherein the route frequency is at least one flight per 1 hour cycle.

15. The method of claim 11, wherein the designated region is marked via a geo-fence.

16. The method of claim 11, wherein an aiming direction of a LiFi transceiver of the edge node is adjustable, and wherein the aiming direction is adjusted while the drone progressively moves overhead of the edge node during the LiFi communication session.

17. The method of claim 11, wherein the designated region is a defined set of global positioning system (GPS) coordinates.

18. The method of claim 11, wherein establishing the LiFi communication session is initiated by the drone.

19. A method comprising:
establishing a route frequency for a flight path of a drone equipped with a light fidelity (LiFi) transceiver, wherein the route frequency indicates how often the drone is to travel the flight path, and wherein the flight path includes a designated region within which an edge node is supposedly located;
causing the drone to travel the flight path to reach the designated region;
while the drone is within the designated region, establishing a LiFi communication session with the edge node, wherein the LiFi communication session is initiated by the drone;
collecting data from the edge node during the LiFi communication session;
terminating the LiFi communication session, said terminating operates as a trigger event for the edge node to purge a memory buffer;
causing the drone to continue along the flight path until reaching an infrastructure node; and
causing the drone to transmit the collected data to the infrastructure node.

20. The method of claim 19, wherein the drone remains approximately stationary while the LiFi communication session is active.
